(19) United States
(12) Patent Application Publication
(10) Pub. No.: US 2004/0261516 A1
(43) Pub. Date: Dec. 30, 2004

(54) Rain gauge

(76) Inventor: John Simpson, Potosi, MO (US)

Correspondence Address: John S. Beulick, Armstrong Teasdale LLP, Suite 2600, One Metropolitan Square, St. Louis, MO, 63102, US

(21) Appl. No.: 10/606,599

(22) Filed: Jun. 26, 2003

(51) Int. Cl. G01W 1/00

(52) U.S. Cl. 73/170.17

(57) ABSTRACT

A rain gauge assembly includes, in an exemplary embodiment, a first hollow cylinder having a side wall and a bottom wall closing a first end of the first cylinder. The first cylinder is open at a second end. The assembly also includes a second hollow cylinder having a side wall and a bottom wall closing a first end of the second cylinder. The second cylinder is open at a second end and has an inside diameter approximately equal to the outside diameter of the first cylinder so that the first cylinder is receivable in the second cylinder. The second cylinder has a length that is less than the length of the first cylinder. The first and second cylinders are molded from a resilient translucent plastisol material. The assembly further includes a means for attaching the second cylinder to a surface.

### BACKGROUND OF THE INVENTION

This invention relates generally to rain gauges, and more particularly to a molded plastisol rain gauge.

Rain gauges are instruments used to measure the amount of rain that falls in a certain place or region during a given period of time, for example, a homeowner's yard. This measurement function is important, because the resultant data can be used to determine the amount of extra irrigation required by crops, lawns, and gardens, as well as determining if sufficient irrigation has been provided. A common type of rain gauge utilizes a transparent glass or plastic tube held in an upright position. Such rain gauges have marks or indicia extending vertically along the lateral surface of the transparent tube to assist in determining the amount of rain water that has fallen. One problem with such known rain gauges are that glass tubes are easily cracked and can lead to leaking gauges and inaccurate readings.

### BRIEF DESCRIPTION OF THE INVENTION

In one aspect, a rain gauge assembly is provided. The rain gauge assembly includes a first hollow cylinder having a side wall and a bottom wall closing a first end of the first cylinder. The first cylinder is open at a second end. The assembly also includes a second hollow cylinder having a side wall and a bottom wall closing a first end of the second cylinder. The second cylinder is open at a second end and has an inside diameter approximately equal to the outside diameter of the first cylinder so that the first cylinder is receivable in the second cylinder. The second cylinder has a length, or height, that is less than the length, or height, of the first cylinder. The first and second cylinders are molded from a translucent plastisol material. The assembly further includes a means for attaching the second cylinder to a surface.

In another aspect, a rain gauge assembly is provided that includes a collection tube having a side wall and a bottom wall closing a first end of the collection tube. The collection tube is open at a second end. The rain gauge assembly also includes a cap member having an open end and a closed end, and that is sized to fit over and cover an end of the collection tube. The collection tube and the cap member are molded from a translucent plastisol material. The assembly further comprises a means of attaching the cap member to a surface.

In another aspect, a rain gauge kit is provided that includes a collection tube having a side wall and a bottom wall closing a first end of the collection tube. The collection tube is open at a second end. The kit also includes a cap having an open end and a closed end, and sized to fit over and cover an end of the collection tube. The collection tube and the cap are molded from a translucent plastisol material. The kit further includes at least one of a fastener and a stake for attaching the cap to a surface.

In another aspect, a method of fabricating a rain gauge assembly is provided. The method includes molding a collection tube from a translucent plastisol material, and molding a cap from the translucent plastisol material. The collection tube includes a side wall and a bottom wall closing a first end of the collection tube with the collection tube open at a second end. The cap includes an open end and a closed end, and is sized to fit over and cover an end of the collection tube.

### BRIEF DESCRIPTION OF THE DRAWINGS

FIG. 1 is a front view of a rain gauge assembly in accordance with an embodiment of the present invention.

FIG. 2 is a front view of the rain gauge assembly shown in FIG. 1 in a collection position.

FIG. 3 is a front view of the rain gauge assembly shown in FIG. 1 in a storage position.

### DETAILED DESCRIPTION OF THE INVENTION

A rain gauge assembly is described below in detail. The rain gauge assembly includes a collection tube, a cap, and a means of attaching the cap to a surface such as a deck railing or the ground to serve as a holder for the collection tube. The collection tube and cap are molded from a translucent plastisol material. Plastisol materials are flexible and resist cracking and breaking.

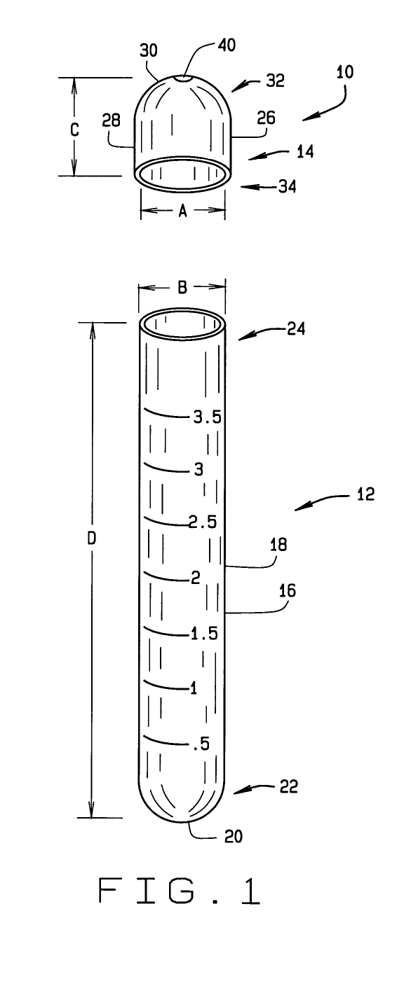

Referring to the drawings, FIG. 1 is a front view of a rain gauge assembly 10 in accordance with an exemplary embodiment of the present invention. Rain gauge assembly 10 includes a collection tube 12 and a cap 14. Collection tube 12 is a first hollow cylinder 16 having a side wall 18 and a bottom wall 20 closing a first end 22 of cylinder 16. First cylinder 16 is open at a second end 24 to enable the collection of rain water or irrigation water. Collection tube 12 also includes marks or indicia spaced vertically along side wall 18 to measure the amount of water collected.

Cap 14 is a second hollow cylinder 26 having a side wall 28 and a bottom wall 30 closing a first end 32 of second cylinder 26. Second cylinder 26 is open at a second end 34 and has an inside diameter A that is approximately equal to an outside diameter B of first cylinder 16 so that first cylinder 16 is receivable in second cylinder 26. This enables cap 14 to be placed over open end 24 of collection tube 12 and also enables cap 14 to be placed over closed end 22 of collection tube 12. Also, second cylinder 26 has a length, or height, C that is less than the length, or height, D of first cylinder 16. Collection tube 12 and cap 14 are molded from a translucent resilient material, for example a translucent plastisol material. Any suitable molding technique, for example spin molding, injection molding, and hot dip molding, can be used to form collection tube 12 and cap 14.

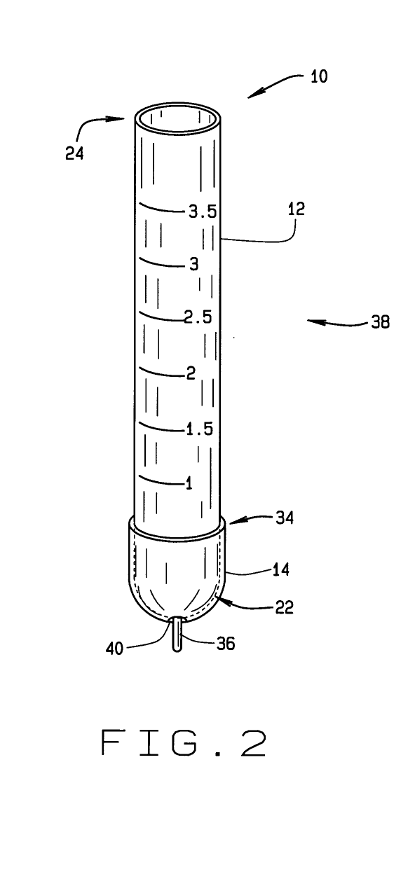

Referring also to FIG. 2, assembly 10 further includes a means 36 for attaching cap 14 to a surface. Typically, cap 14 is attached to a surface with open end 34 facing upward to permit closed end 22 of collection tube 12 to be inserted into cap 14. In this collection position 38, collection tube 12 is held vertically upright with open end 24 facing upward to collect rain falling from the sky. Cap 14 can be attached to any surface that will permit assembly 10 to be arranged in collection position 38, for example, the surface of a deck, a deck railing, a stand extending from a building, and the ground. Means 36 can include any suitable fastener and/or stake that is capable of attaching cap 14 to a surface. Cap 14 includes an opening 40 sized to permit attaching means 36 to extend through bottom wall 30.

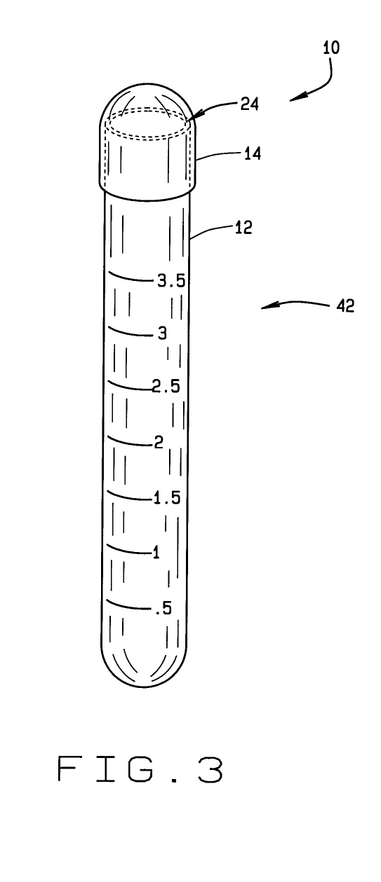

FIG. 3 shows rain gauge assembly 10 in a storage position 42 with cap 14 placed over open end 24 of collection tube 12. In storage position 42, attaching means 36 can be stored inside collection tube 12.

Any suitable plastisol material can be used to form rain gauge 10. Plastisol materials, for example vinyl plastisols, that are translucent are preferred because they permit viewing through side wall 18 of collection tube 12 to determine the amount of water collected. Also, it is preferable that the vinyl plastisol material does not absorb moisture. The absorption of moisture in some translucent plastisol materials can turn the material “cloudy” or “milky” which obscures the viewing of the amount of collected water through side wall 18 of collection tube 12. Further, the vinyl plastisol materials can contain pigments and/or dyes to impart a color in rain gauge 10.

Collection tube 12 and cap 14 are molded using any suitable technique, for example spin molding, injection molding, and hot dip molding utilizing a mandrel. The freshly molded shape is cured at an elevated temperature and then removed from the mandrel. The indicia are then applied to side wall 18 of collection tube 18. Any suitable material can be used for the indicia, for example, paint, ink, plastic tape, and the like. In the exemplary embodiment, a light or heat curable ink is applied to side wall 18 to form the indicia. In alternative embodiments, other text and symbols, for example company logos can be applied to side wall 18 in addition to the indicia.

While the invention has been described in terms of various specific embodiments, those skilled in the art will recognize that the invention can be practiced with modification within the spirit and scope of the claims.

What is claimed is:

1. A rain gauge assembly comprising:
a first hollow cylinder having a side wall and a bottom wall closing a first end of said first cylinder, said first cylinder open at a second end and having an outside diameter;
a second hollow cylinder having a side wall and a bottom wall closing a first end of said second cylinder, said second cylinder open at a second end and having an inside diameter approximately equal to said outside diameter of said first cylinder so that said first cylinder is receivable in said second cylinder, said second cylinder having a length that is less than a length of said first cylinder, said first and second cylinders molded from a resilient translucent plastisol material; and
a means for attaching said second cylinder to a surface.

2. A rain gauge assembly in accordance with claim 1 wherein said first cylinder comprises indicia located on said side wall for measuring a collected contents of said first cylinder.

3. A rain gauge assembly in accordance with claim 1 wherein said means for attaching said second cylinder to a surface comprises at least one of a fastener and a stake.

4. A rain gauge assembly in accordance with claim 1 wherein said first end of said first cylinder is positioned inside said second cylinder to define a collection position.

5. A rain gauge assembly in accordance with claim 1 wherein said second end of said first cylinder is positioned inside said second cylinder to define a storage position.

6. A rain gauge assembly in accordance with claim 1 wherein said bottom wall of said second cylinder comprises an attachment opening sized to receive said means for attaching said second cylinder to a surface.

7. A rain gauge assembly in accordance with claim 1 wherein said plastisol material comprises at least one of a pigment and a dye.

8. A rain gauge assembly comprising:
a collection tube comprising a side wall and a bottom wall closing a first end of said collection tube, said collection tube open at a second end;
a cap member comprising an open end and a closed end, and sized to fit over and cover an end of said collection tube, said collection tube and said cap member molded from a resilient translucent plastisol material; and
a means of attaching said cap member to a surface.

9. A rain gauge assembly in accordance with claim 8 wherein said collection tube comprises indicia located on said side wall for measuring a collected contents of said collection tube.

10. A rain gauge assembly in accordance with claim 8 wherein said means for attaching said cap to a surface comprises at least one of a fastener and a stake.

11. A rain gauge assembly in accordance with claim 8 wherein said first end of said collection tube is positioned inside said cap element to define a collection position.

12. A rain gauge assembly in accordance with claim 8 wherein said second end of said collection tube is positioned inside cap element to define a storage position.

13. A rain gauge assembly in accordance with claim 8 wherein said closed end of said cap element comprises an attachment opening sized to receive said means for attaching said cap element to a surface.

14. A rain gauge assembly in accordance with claim 8 wherein said plastisol material comprises at least one of a pigment and a dye.

15. A rain gauge kit comprising:
a collection tube comprising a side wall and a bottom wall closing a first end of said collection tube, said collection tube open at a second end;
a cap comprising an open end and a closed end, and sized to fit over and cover an end of said collection tube, said collection tube and said cap molded from a resilient translucent plastisol material; and
at least one of a fastener and a stake for attaching said cap to a surface.

16. A kit in accordance with claim 15 wherein said collection tube comprises indicia located on said side wall for measuring a collected contents of said collection tube.

17. A kit in accordance with claim 15 wherein said closed end of said cap comprises at least one attachment opening sized to receive said at least one of a fastener and a stake.

18. A kit in accordance with claim 15 wherein said plastisol material comprises at least one of a pigment and a dye.

19. A method of fabricating a rain gauge assembly, said method comprising:
molding a collection tube from a resilient translucent plastisol material; and
molding a cap from the translucent plastisol material;
the collection tube comprising a side wall and a bottom wall closing a first end of the collection tube, the collection tube open at a second end;
the cap comprising an open end and a closed end, and sized to fit over and cover an end of the collection tube.

20. A method in accordance with claim 19 further comprising applying a plurality of spaced indicia to an outer surface of the side wall of the collection tube.

21. A method in accordance with claim 20 further comprising applying at least one of text and a symbol in addition to the indicia.

22. A method in accordance with claim 19 wherein the plastisol material comprises at least one of a pigment and a dye.
